(19) United States
(12) Patent Application Publication
(10) Pub. No.: US 2020/0110606 A1
(43) Pub. Date: Apr. 9, 2020

(54) DETECTION AND ELIMINATION OF RUNTIME VISIBILITY GAPS IN TRANSACTIONS

(71) Applicant: CA, Inc., New York, NY (US)

(72) Inventors: Ramesh Mani, Fremont, CA (US); Anand Krishnamurthy, Fremont, CA (US); Vashistha Kumar Singh, Cupertino, CA (US)

(21) Appl. No.: 16/155,792

(22) Filed: Oct. 9, 2018

(51) Int. Cl. G06F 9/30; G06F 9/455; G06F 11/34

(52) U.S. Cl. CPC G06F 9/3017; G06F 2009/45591; G06F 11/3466; G06F 9/45558

(57) ABSTRACT

To increase visibility into an application's performance, an application performance management system monitors transactions of an application at runtime to identify components or methods which significantly contribute to the execution of the transaction but are not instrumented. Since these methods are uninstrumented, the application performance management system has no visibility into and does not receive performance metrics for the methods. Identified components which contribute to the transaction are instrumented to decrease the visibility gap and provide additional performance information about the transaction of the application. During visibility gap detection, the agent analyzes runtimes of instrumented components to identify a component with a largest attributable runtime. The component is analyzed to identify uninstrumented, children components which it invokes. One or more of these children components may be instrumented and reloaded into an application to provide performance information during a subsequent execution of the component.

### BACKGROUND

The disclosure generally relates to the field of data processing, and more particularly to software development, installation, and management.

An application agent deployed by an application performance management (“APM”) system instruments application code to facilitate monitoring, triaging, and diagnosing application performance issues. The agent can trace components involved in a transaction and the order in which the components are executed. The agent may also instrument program code to provide visibility into performance or metrics of the components executed during the transaction.

### BRIEF DESCRIPTION OF THE DRAWINGS

Embodiments of the disclosure may be better understood by referencing the accompanying drawings.

FIG. 1 depicts an example application performance management system which detects visibility gaps and identifies application code to instrument in order to eliminate visibility gaps.

FIG. 2 is a flowchart of example operations for runtime identification of components which have visibility gaps.

FIG. 3 is a flowchart of example operations for instrumenting a component to eliminate a visibility gap in a transaction.

FIG. 4 depicts an example computer system with a visibility gap detector which identifies components with visibility gaps for addition of instrumentation in order to eliminate the visibility gap in subsequent transactions.

### DESCRIPTION

The description that follows includes example systems, methods, techniques, and program flows that embody aspects of the disclosure. However, it is understood that this disclosure may be practiced without these specific details. For instance, this disclosure refers to instrumenting methods of an application executing within a Java Virtual Machine environment in illustrative examples. Aspects of this disclosure can be also applied to functions, scripts, components, or processes of applications running in other environments, such as an application running in a containerized environment. In other instances, well-known instruction instances, protocols, structures and techniques have not been shown in detail in order not to obfuscate the description.

Introduction

Instrumenting every component or method in an application to monitor performance may not be feasible due to the number of components and can create performance issues with the application. Since not every component is instrumented, performance issues occurring in components which are not instrumented (“uninstrumented components”) may not be visible to an application performance management system. As a result, application components should be intelligently instrumented to provide maximum visibility into an application's performance in order to facilitate identification and diagnosis of application performance issues.

Overview

To increase visibility into an application's performance, an APM system monitors transactions of an application at runtime to identify components or methods which significantly contribute to the execution of the transaction but are not instrumented. Since these methods are uninstrumented, the APM system has no visibility into and does not receive performance metrics for the methods. The APM system, therefore, may be said to have a visibility gap for the transaction. Identified components which contribute to the transaction are instrumented to decrease the visibility gap and provide additional performance information about the transaction of the application.

During visibility gap detection, the agent analyzes runtimes of instrumented components to identify a component with a largest attributable runtime. This component which significantly contributes to an overall runtime of a transaction may be said to contain a visibility gap as the component likely invokes other components which are not instrumented. The component is analyzed to identify uninstrumented, children components which it invokes. One or more of these children components may be instrumented and reloaded into an application to provide performance information during a subsequent execution of the component. Components which have previously been instrumented during visibility gap analysis may have instrumentation removed if the component does not provide additional visibility in the transaction, allowing for other components to be instrumented. As a result, visibility of an application improves due to ongoing inspection and instrumentation of components and ultimately leads to instrumentation of components which most significantly contribute to a runtime of an application.

### Example Illustrations

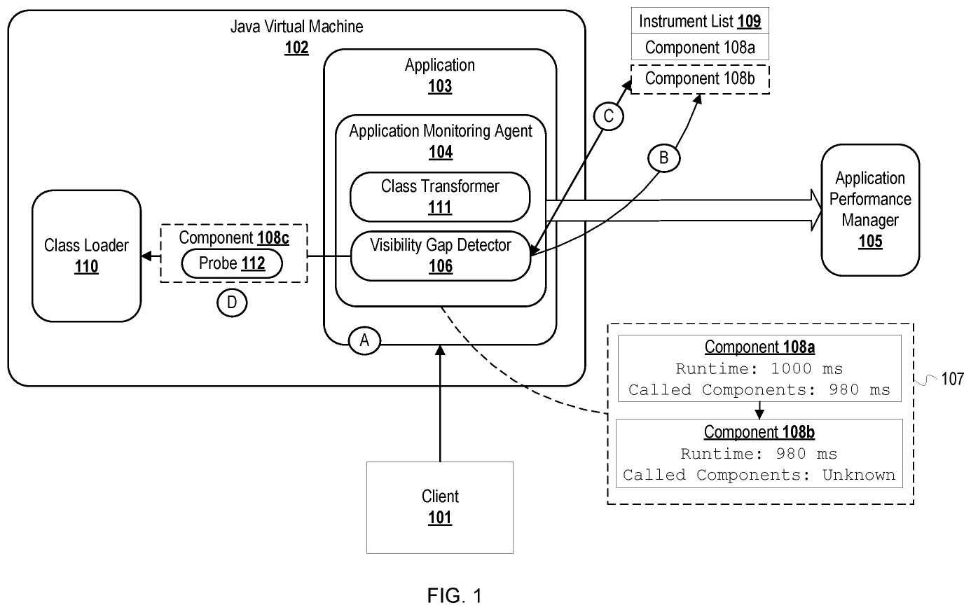

FIG. 1 depicts an example application performance management system which detects visibility gaps and identifies application code to instrument in order to eliminate visibility gaps. FIG. 1 depicts an application monitoring agent 104 (“agent 104”) deployed in an application 103 running on a Java Virtual Machine (JVM) 102. The agent 104 comprises a visibility gap detector 106 and a class transformer 111 which communicates with a class loader 110 that is part of the JVM 102. The agent 104 communicates with an APM 105. A client 101 communicates with the application 103.

At stage A, the client 101 issues a request to the application 103. A thread of the application 103 in the JVM 102 is initialized as part of a transaction for executing the request. Components which are invoked as part of a transaction are traced and performance data is tracked for instrumented components which are called during execution of the transaction. Components may have been instrumented with probes defined by probe directive files (PBDs), smart instrumentation, entry point detection, or exit point detection. Instrumentation can involve inserting program code into a component of the application, assigning a process to monitor for execution of byte code related to the component, etc. Instrumentation is configured to record and report component performance metrics to the agent 104 which communicates the metrics to the APM 105. The agent 104 may store the component call information and any collected performance information in a stack data structure 107 (“stack 107”), sometimes referred to as a runtime data stack. The stack 107 may be a data structure such as a two-dimensional array or a table which lists invoked components and information for each component.

As shown in FIG. 1, the stack 107 displays the components which were called during execution of the request (“transaction components”): the component 108a was invoked, which invoked the component 108b. For instrumented components, the stack 107 can include data fields for performance metrics such as a runtime of the component and a cumulative runtime of components called by the component (“called component duration”). Components 108a and 108b have been instrumented, and as a result, the runtime of each of the components 108a and 108b is received by the agent 104 and stored in the stack 107 in a “Runtime” field. Since the component 108b which is invoked by the component 108a is instrumented, the “Called Components” field of the component 108a can be populated with the runtime of the component 108b. Using the overall runtime and called component runtime values, a runtime attributable to a given component can be determined by subtracting the called component runtime from the component runtime. For the component 108a, the attributable runtime is 20 milliseconds (1000 ms−980 ms=20 ms). For components which have not been instrumented by the agent 104, performance data is not available. So, since no components invoked by the component 108b are instrumented, the runtime of the called components of the component 108b is unknown, and the attributable runtime to the component 108b is considered to be the full 980 ms.

A runtime data stack can be created for each transaction initiated in response to a client request. Stack fields may be updated upon component execution events. For example, when execution of a component called by a parent component ends, the runtime of the called component is added to the “Called Components” field in the parent component runtime data stack. In addition to the “Runtime” and “Called Components” fields shown in FIG. 1, the stack 107 can include a field for each invoked component identifying a parent component (i.e. the calling component), for a pointer to an exception log for the component, identification of invoked component, etc.

At stage B, upon completion of the transaction initiated at stage A, the visibility gap detector 106 identifies a component which has a largest visibility gap in the transaction represented by the stack 107. A component with a visibility gap is an instrumented component with a runtime accounting for a high proportion of the overall transaction runtime and likely invokes components which are not instrumented. Because the invoked components are not instrumented, the agent 104 is unable to obtain performance metrics from the components and, thus, lacks visibility into these components which account for a significant portion of runtime of the transaction. To calculate a component visibility gap, the visibility gap detector 106 computes the difference between the component runtime and the called component duration for each instrumented component. The values are obtained from the corresponding fields in the runtime data stack. Component 108a exhibits a total runtime of 1000 milliseconds and that of its called components is 980 milliseconds, so the component 108a has a visibility gap of 20 milliseconds. The component 108b's visibility gap is 980 milliseconds, as the unknown duration of the called components can be treated as 0 milliseconds for purposes of the visibility gap calculation. As a result, the visibility gap detector 106 selects the component 108b for further instrumentation since the component 108b has the largest visibility gap.

The above process for selecting a component with a largest visibility gap may occur as the transaction is executing. For example, each time a new entry for a component is added to the stack 107, the visibility gap detector 106 may perform a visibility gap calculation for the new component and track a component with the largest calculated visibility gap (“visibility gap candidate”). Once the visibility gap of a component has been calculated, the visibility gap detector 106 compares the visibility gap calculated for the new component with that of the visibility gap candidate. If the new component visibility gap is greater than that of the current visibility gap candidate, the visibility gap candidate field is updated to reflect the new component as the new visibility gap candidate. The visibility gap detector 106 continues calculating component visibility gaps and comparing the visibility gaps with the current candidate for each transaction component until the transaction is complete. A transaction may be considered complete once a response has been sent for the request or once the thread of the JVM 102 initiated in response to the request has terminated. The visibility gap candidate remaining at the end of the transaction identifies the component which was found to have the largest visibility gap while executing the request. After determining that the component 108b has the largest potential visibility gap, the visibility gap detector 106 adds an identifier for the component 108b to a global list of components to inspect for further instrumentation (“instrument list”) 109.

At stage C, the visibility gap detector 106 inspects the instrument list 109 to determine which components should be inspected for further instrumentation. The visibility gap detector 106 may associate flags with the components on the instrument list 109 which indicate if the component has already been instrumented. Upon identifying that the component 108b has not yet been selected for instrumentation, the visibility gap detector 106 selects the component 108b for further instrumentation. The visibility gap detector 106 inspects the component 108b for further instrumentation by parsing the component byte code to identify components invoked or called by the component 108b. This list of invoked components is filtered by eliminating components which are already instrumented; components belonging to classes which are not included in entries in the probe directive file provided from previous instrumentation; components belonging to classes which cannot be redefined (e.g., the Java String class); components which perform assignments without calling additional components, such as “get” and “set” methods; and components which have been added to a list of components which should not be instrumented or from which instrumentation should be removed. In FIG. 1, the visibility gap detector 106 determines that a component 108c which is invoked by the component 108b can be instrumented and instruments the component 108c by adding a probe 112. The probe 112 may be program code which is configured to report performance metrics to the agent 104 or may be program code which invokes a separate process that monitors the component 108c. In some instances, the component 108b may have multiple invoked components eligible for instrumentation. In such instances, the visibility gap detector 106 may add all of the eligible components to the instrument list 109 or may select a component first invoked by the component 108b for instrumentation, leaving subsequently invoked components for instrumentation after later transactions. After instrumenting invoked components, the visibility gap detector 106 updates the flag for the component on the instrument list 109 to indicate that the component 108b has been processed for further instrumentation.

At stage D, the visibility gap detector 106 invokes the class loader 110 to reload a class containing the newly instrumented component 108c. The class loader 110 modifies the class definition for the instrumented component 108c and invokes the class transformer 111 for transforming the class of the instrumented component 108c. After invocation by the class loader 110, the class transformer 111 transforms class file bytes to account for the instrumentation which has been applied to the component 108c and returns the transformed class file bytes. The class is reloaded so that the instrumentation applied to the component 108c will be active in subsequent transactions. In subsequent transactions, the now instrumented component 108c will appear in the stack 107 along with performance information for the component 108c.

During subsequent transactions, a component instrumented as a result of the visibility gap detection process described above may be inspected for removal of instrumentation. Instrumentation may be removed from the component if it is determined that instrumenting the component did not provide additional visibility into the performance of the application 103. When a newly instrumented component is subsequently executed, the visibility gap detector 106 calculates the runtime attributable to the component. Attributable component runtime is determined similarly to the visibility gap by subtracting the value stored in the called component duration field in the runtime data stack from the value stored in the component runtime field. The visibility gap detector 106 compares the attributable runtime to a threshold value to determine if the instrumentation of the component provides sufficient additional visibility to warrant the overhead of the additional instrumentation. The threshold may be a specified time such as 10 milliseconds or may be a percentage value related to the runtime of a component in relation to an overall transaction runtime. For example, if a transaction takes 100 milliseconds to execute, a component which has an attributable runtime of 5 milliseconds only accounts for 5% of the overall runtime, which is less than a possible threshold of 10%. If the attributable runtime fails to satisfy to the threshold, the visibility gap detector 106 determines that the component does not improve visibility or provide sufficient visibility. The visibility gap detector 106 therefore adds an identifier for the component to a global list of components for which instrumentation will be removed. The visibility gap detector 106 may inspect the list to identify the component for removal of instrumentation, remove component instrumentation, and reload the class similarly to the process described with reference to stages C and D in FIG. 1. An identifier for the component may remain on the instrumentation removal list so that the component will not be instrumented again in the future.

The operations depicted at stage C may occur periodically and can occur concurrently with operations depicted at stages A and B. For example, the visibility gap detector 106 may inspect the list 109 on alternate transactions. The visibility gap detector 106 may also inspect the list after receiving a notification that a component has been added to the instrument list 109. Alternatively, the visibility gap detector 106 may be dispatched to inspect the instrument list 109 after a designated time period has passed. Additionally, the operations for checking the instrument list 109 may be performed by another thread of the agent 104 which passes identifiers for components to be inspected for further instrumentation to the visibility gap detector 106.

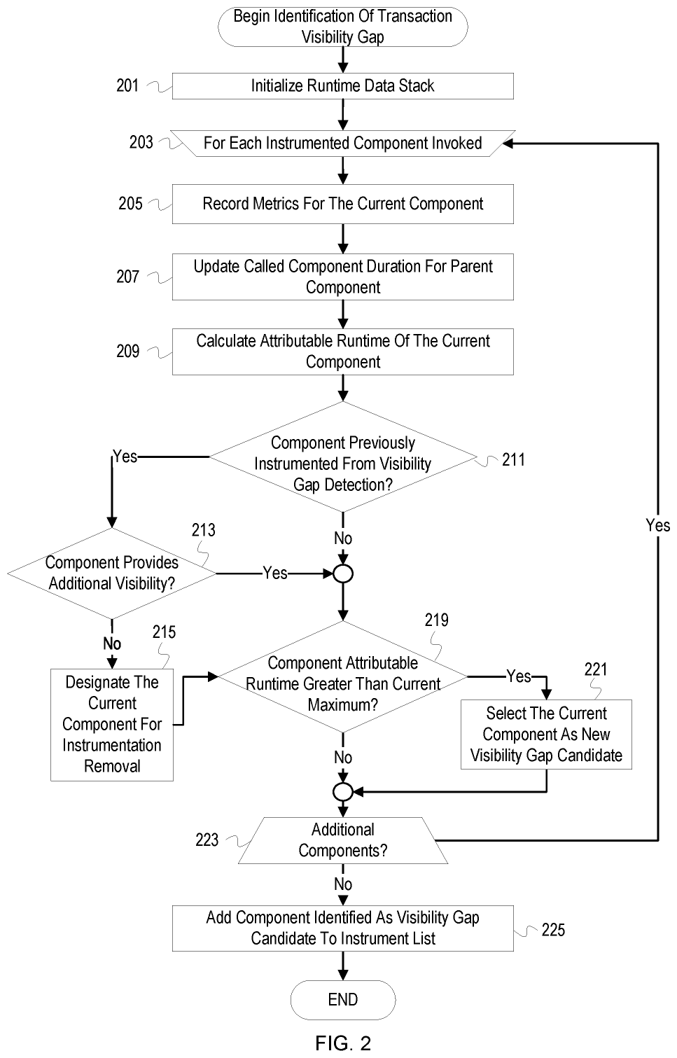

FIG. 2 is a flowchart of example operations for identification of components with visibility gaps. FIG. 2 depicts operations which may be performed by a visibility gap detector implemented in an agent which an APM system has deployed to an application. The example operations refer to a visibility gap detector as performing the depicted operations for consistency with FIG. 1, although naming of software and program code can vary among implementations. Operations depicted in FIG. 2 can be repeated for each transaction of an application.

A visibility gap detector initializes a runtime data stack in response to detecting a new transaction (201). Execution of a transaction initiates upon receipt of a client request. The visibility gap detector creates a runtime data stack to store component metrics recorded for each instrumented component called in the transaction. The visibility gap detector may allocate memory space for the runtime data stack and initialize an array for storing the component metrics.

The visibility gap detector begins visibility gap analysis for each instrumented component which is invoked during the transaction (203). The visibility gap detector monitors the transaction and performs operations for each invoked component. The invoked component for which operations are being performed is hereinafter referred to as “the current component.”

The visibility gap detector records metrics for the current component (205). The runtime data stack is updated to store runtime information which is calculated during execution of the current component, such as component runtime. Once execution of the current component ends, the runtime is stored in the component runtime field in the runtime data stack. The runtime accounts for runtime of the current component and any instrumented components which it invokes. Other information for the component may be recorded such as whether any faults or errors occurred, invoked components, etc.

The visibility gap detector updates the called component duration of the parent component (207). The parent component is the component which invoked the current component. To update the called component duration of the parent, the current component runtime is added to the called component duration field of the parent component in the runtime data stack.

The visibility gap detector calculates the attributable runtime of the current component (209). The attributable runtime of a component is an amount of time taken by the current component during the execution of the transaction. The attributable runtime is determined by determining the difference between the overall component runtime and the called component duration. For example, the runtime of the current component may be 20 seconds, and the called component duration may be 15 seconds, resulting in an attributable runtime of 5 seconds. Runtime values are obtained from the runtime data stack in fields corresponding to the current component. If components invoked by the current component are not instrumented, the “called component duration” field of the current component may be equal to 0 or null as the runtime of these components is unknown. In such instances, the overall runtime is all considered attributable to the current component.

The visibility gap detector determines if the current component was previously instrumented as a result of visibility gap detection (211). Specified components of an application may be instrumented by default, e.g. entry point components, components which are a main method, components corresponding to Application Programming Interface (API) calls. These components remain instrumented as part of the default instrumentation practice. Components identified as containing a visibility gap may be optionally instrumented as described herein. Components which have been previously instrumented due to causing a visibility gap may be examined for removal of instrumentation upon being invoked in subsequent transactions.

If component instrumentation was added as a result of visibility gap detection, the visibility gap detector determines if the component provides additional visibility into the transaction (213). The value of the attributable runtime is compared to a threshold to determine if the instrumentation which was previously added as a result of visibility gap detection should be removed. The threshold may be an amount of time, e.g., 5 milliseconds, and may be adjusted based on an overall runtime of a transaction or a number of components currently instrumented. For example, the higher the overall runtime the higher the threshold and vice versa. As an additional example, an upper limit may be set on a total number of components which can be instrumented, and the threshold can be adjusted higher if the number of instrumented components is at or near the limit. If the attributable runtime of the current component is less than the threshold, then the visibility gap detector determines that the current component does not provide enough visibility into the transaction to warrant instrumentation. Across iterations of the visibility gap analysis, a component may be uninstrumented, and children components may be instrumented and uninstrumented until a component which satisfies the visibility threshold is identified. For example, after instrumenting a component A, it can be determined that the component A includes a visibility gap, so a component B invoked by the component A is instrumented. Once the component B is instrumented, the runtime information of the component B may be used to determine that the visibility provided by instrumenting the component A was only 1 millisecond, so the component A is then designated for removal of instrumentation. After a subsequent transaction, a component C invoked by the component B may be instrumented. The runtime information of the component C may reveal that the component B's attributable runtime is 20 milliseconds which satisfies the threshold so the component B remains instrumented. This iterative process of removing and adding instrumentation allows for the components which provide the greatest visibility to be identified and instrumented.

If the attributable runtime of the current component fails to satisfy the threshold, the visibility gap detector designates the current component for removal of instrumentation (215). The current component can be added to a list of components for instrumentation removal which is periodically checked by another process. A flag may be associated with the component once it is added to the list to indicate that it has not yet been selected for removal of instrumentation. Once a component has been identified as providing no additional or insufficient visibility, the current component may remain on the removal list so that it is not instrumented again after a future transaction.

After the operations of blocks 211, 213, and 215, the visibility gap detector determines whether the component's attributable runtime is greater than a current maximum attributable runtime (219). The visibility gap detector tracks the component with the largest attributable runtime determined throughout a transaction execution. The visibility gap detector compares the attributable runtime for the current component to a current highest determined attributable runtime for a component. The component with the highest attributable runtime is referred to as the visibility gap candidate because the component likely invokes an uninstrumented component which contributes to a transaction's runtime and is not visible for purposes of obtaining performance information.

If the current component's attributable runtime is greater than that of a current visibility gap candidate, the visibility gap detector selects the current component as the new visibility gap candidate (221). The visibility gap candidate has the largest potential visibility gap currently known from visibility gap analysis at that point of the transaction. In some implementations, before selecting the current component as a visibility gap candidate, the visibility gap detector may determine if the current component has been previously designated for instrumentation removal or is otherwise excluded from instrumentation.

After determining whether the current component is the new visibility gap candidate, the visibility gap detector determines whether there is an additional invoked instrumented component (223). If there is an additional component, the visibility gap detector selects the next component for analysis (203).

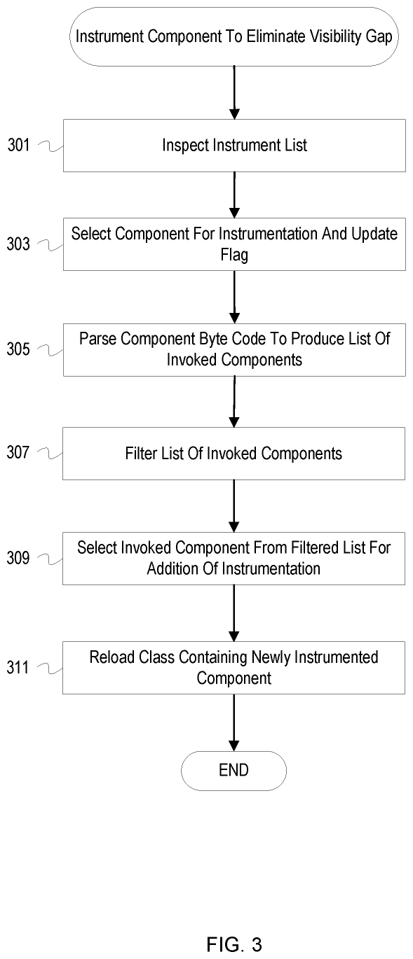

If there is not an additional component, the visibility gap detector adds an identifier for the visibility gap candidate to a list of components to be instrumented (225). The instrument list may contain identifiers for components executed in each transaction which the agent monitors. The component identifier may be associated with a flag indicating that the component has not been selected for instrumentation. The visibility gap candidate component will be inspected to identify components invoked by the component for addition of instrumentation to eliminate visibility gaps as described in FIG. 3.

FIG. 3 is a flowchart of example operations for instrumenting a component to eliminate a visibility gap in a transaction. FIG. 3 depicts operations which may be performed by a visibility gap detector executing in an APM agent which has been deployed to monitor an application. The example operations refer to a visibility gap detector as performing the depicted operations for consistency with FIG. 1, although naming of software and program code can vary among implementations.

The visibility gap detector inspects the instrument list (301). The visibility gap detector may dispatch a thread to inspect the instrument list. The list contains components which have been identified as having a visibility gap in a transaction in a respective transaction in which each of the components was invoked. The visibility gap detector may inspect flags associated with components on the instrument list. The flags indicate whether the component has previously been selected for instrumentation.

The visibility gap detector selects a component for instrumentation and updates the flag associated with the component on the instrument list (303). The visibility gap detector identifies a component for which the flag does not indicate that the component has previously been instrumented. The component flag is then updated on the instrument list to reflect that the component has been selected for instrumentation. Flags are updated such that selected components will not be selected for instrumentation in subsequent inspections of the instrument list. The component which is selected for instrumentation is hereinafter referred to as the “selected component.”

The visibility gap detector parses the selected component byte code to produce a list of invoked components (305). The parsed byte code is inspected to identify each of the components which the selected component invokes during execution. The list of invoked components identified by parsing the selected component byte code includes components which lack instrumentation and are therefore not visible in a runtime data stack created for a transaction as well as components which may have been previously instrumented.

The visibility gap detector filters the list of invoked components (307). The list is filtered based on predetermined criteria which indicate categories of components to which instrumentation should not be added. Such components are eliminated from the list of invoked components. For instance, the criteria may indicate to eliminate components for which the corresponding class was not included in the probe directory file for the selected component, components corresponding to classes which cannot be redefined (e.g., the Java String class), and components which perform assignments and/or do not invoke additional components (e.g., “get” or “set” values). The filtered list contains invoked components which satisfy the instrumentation criteria.

The visibility gap detector selects an invoked component from the filtered list for addition of instrumentation (309). The visibility gap detector may choose any of the remaining invoked components for instrumentation. If the filtered list contains more than one component which is eligible for instrumentation, the visibility gap detector may choose multiple components. Instrumentation may be applied to the selected component or components through the addition of a probe which reports performance metrics or otherwise monitors performance of the instrumented component.

The visibility gap detector invokes the class loader to reload the class which contains the newly instrumented component (311). The class loader invokes a class transformer to transform the class bytes before the class is redefined. After the class is transformed and reloaded, performance metrics and runtime data can be obtained for the newly instrumented component in subsequent transactions in which it is invoked. The runtime data will be visible in the runtime data stack initialized for such transactions and may be reported to an APM. After reloading the newly instrumented component, the process ends or may be repeated for additional components indicated in the instrument list.

Operations similar to those discussed in FIG. 3 may be performed for removing instrumentation from a component. The visibility gap detector checks an instrumentation removal list and selects an indicated component for removal of instrumentation. The class loader then reloads the class which comprises the selected component so that instrumentation is removed.

Variations

FIG. 1 is annotated with a series of letters A-D. These letters represent stages of operations, each of which may be one or more operations. Although these stages are ordered for this example, the stages illustrate one example to aid in understanding this disclosure and should not be used to limit the claims. Subject matter falling within the scope of the claims can vary with respect to the order and some of the operations.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 207 and 209 can be performed in parallel or concurrently. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

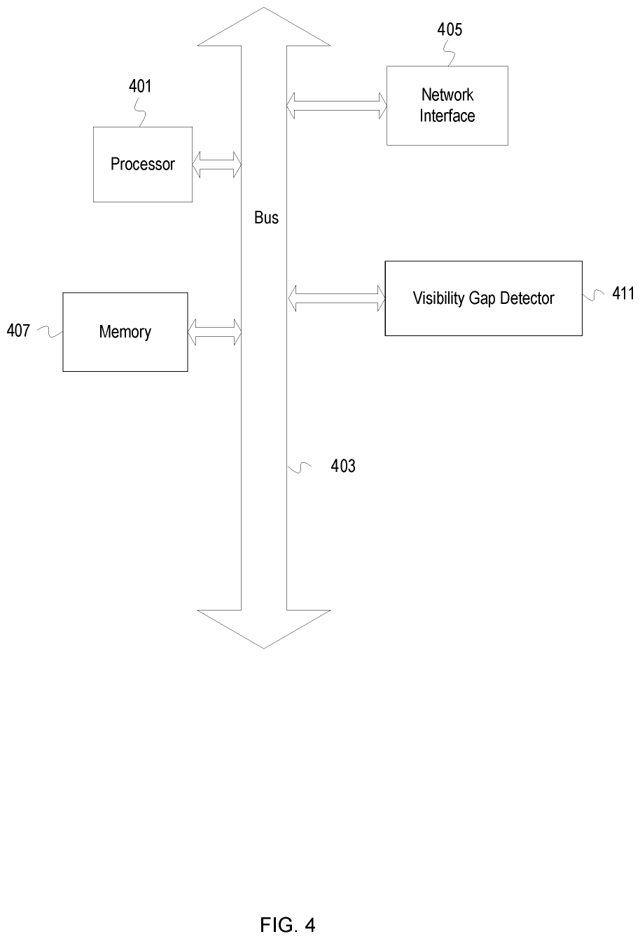

FIG. 4 depicts an example computer system with a visibility gap detector. The computer system includes a processor 401 (possibly including multiple processors, multiple cores, multiple nodes, and/or implementing multi-threading, etc.). The computer system includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 403 (e.g., PCI, ISA, PCI-Express, HyperTransport® bus, InfiniBand® bus, NuBus, etc.) and a network interface 405 (e.g., a Fiber Channel interface, an Ethernet interface, an internet small computer system interface, SONET interface, wireless interface, etc.). The system also includes a visibility gap detector 411. The visibility gap detector 411 identifies transaction components which have a visibility gap and applies instrumentation to components which the transaction components with a visibility gap invoke in order to eliminate the visibility gap. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

While the aspects of the disclosure are described with reference to various implementations and exploitations, it will be understood that these aspects are illustrative and that the scope of the claims is not limited to them. In general, techniques for runtime detection and elimination of transaction visibility gaps as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
identifying a set of components of an application invoked in response to a first request, wherein at least a first component of the set of components is instrumented with program code to report performance information to an agent monitoring the application;
based on determining that the first component has a significant runtime relative to known runtimes of the set of components, analyzing the first component to identify a first child component invoked by the first component which is not instrumented; and
applying instrumentation to the first child component.

2. The method of claim 1 further comprising:
after processing of a second request, receiving performance information from the first child component in accordance with the instrumentation; and
determining whether the performance information indicates that the first child component contributes more than a threshold amount to a processing time of the second request; and
based on determining that the performance information indicates that the first child component contributes less than the threshold amount to a processing time of the second request, removing the instrumentation from the first child component.

3. The method of claim 2 further comprising:
analyzing the first child component to identify a second child component invoked by the first child component; and
applying instrumentation to the second child component.

4. The method of claim 2, wherein determining whether the performance information indicates that the first child component contributes more than a threshold amount to a processing time of the second request comprises:
determining from the performance information an overall runtime of the first child component and a cumulative runtime of components invoked by the first child component;
subtracting the overall runtime from the cumulative runtime of the invoked components to determine an amount of runtime contributable to the first child component; and
comparing the amount of contributable runtime to the threshold amount.

5. The method of claim 1, wherein applying instrumentation to the first child component comprises:
adding, by a first process of the agent, an identifier for the first child component a list of components to be instrumented; and
periodically checking, by a second process of the agent, the list of components to be instrumented; and
based on detecting that the identifier for the first child component has been added to the list, modifying the first child component to include program code for reporting performance information to the agent.

6. The method of claim 5 further comprising, modifying the first child component to include program code for reporting performance information to the agent, sending instructions to reload a class comprising the first child component.

7. The method of claim 1, wherein determining that the first component has a significant runtime relative to known runtimes of the set of components comprises:
for each component in the set of components which is instrumented to report performance information to the agent,
determining from the performance information a runtime of the component; and
comparing the runtime to runtimes of the other instrumented components.

8. The method of claim 1, wherein analyzing the first component to identify a first child component invoked by the first component comprises identifying components invoked by the first component based, at least in part, on byte code of the first component.

9. A non-transitory, computer-readable medium having instructions stored thereon that are executable by a computing device to perform operations comprising:
for each instrumented method invoked as part of a first transaction, determining a runtime contributable to the instrumented method;
identifying one or more methods invoked by a first instrumented method as part of the first transaction based, at least in part, on the first instrumented method having a longest contributable runtime; and
based on determining that the one or more methods are not instrumented, instrumenting at least one of the one or more methods.

10. The computer-readable medium of claim 9 further comprising instructions executable by a computing device to perform operations comprising:
determining a contributable runtime for each of the one or more methods after execution of a second transaction; and
based on determining that the contributable runtime of a first method of the one or more methods is below a threshold, removing instrumentation from the first method.

11. The computer-readable medium of claim 10, wherein the instructions executable by a computing device to perform the operations comprising removing instrumentation from the first method comprises instructions executable by a computing device to perform operations comprising:
adding the first method to a list of methods from which instrumentation is to be removed; and
based on detecting that the first method has been added to the list, modifying the first method to remove instrumentation.

12. The computer-readable medium of claim 9, wherein the instructions executable by a computing device to perform the operations comprising determining the runtime contributable to the instrumented method comprises instructions executable by a computing device to perform operations comprising:
determining a total runtime of the instrumented method and a cumulative runtime of methods invoked by the instrumented method; and
subtracting the total runtime from the cumulative runtime of the invoked methods to determine the contributable runtime of the instrumented method.

13. The computer-readable medium of claim 9 further comprising instructions executable by a computing device to perform operations comprising:
identifying methods invoked by a second instrumented method as part of a second transaction based, at least in part, on the second instrumented method having a longest contributable runtime; and
based on determining that the methods invoked by the second instrumented method are already instrumented, identifying methods invoked by a third instrumented method as part of the second transaction based, at least in part, on the third instrumented method having a second longest contributable runtime.

14. The computer-readable medium of claim 9 further comprising instructions executable by a computing device to perform operations comprising:
identifying a class comprising a first method of the one or more methods; and
based on determining that the class cannot be redefined, determining that the first method cannot be instrumented.

15. An apparatus comprising:
a processor; and
a computer-readable medium having instructions stored thereon that are executable by the processor to cause the apparatus to,
determine that a first component of an application invoked in response to a first request is not instrumented;
apply instrumentation to the first component;
after execution of a second request, determine whether the instrumentation of the first component provided additional visibility for performance information of the application, wherein the instructions to determine whether the instrumentation of the first component provided additional visibility for performance information of the application comprises instructions to,
determine a total runtime of the first component and a cumulative runtime of components invoked by the first component; and
subtract the total runtime from the cumulative runtime of the invoked components to determine a contributable runtime of the first component; and
based on a determination that the instrumentation of the first component provided no additional visibility for performance information of the application,
remove the instrumentation of the first component; and
instrument a second component invoked by the first component.

16. The apparatus of claim 15, wherein the instructions to determine that the first component of the application invoked in response to the first request is not instrumented is executed based on a determination that a parent component of the first component had a longest runtime of components of the application.

17. The apparatus of claim 15, wherein the instructions to apply instrumentation to the first component comprises instructions to:
modify the first component to include program code for reporting performance information to an agent; and
execute instructions to reload a class comprising the first component.

18. The apparatus of claim 15, wherein the instructions to determine whether the instrumentation of the first component provided additional visibility for performance information of the application comprises instructions to compare the contributable runtime of the first component to a threshold.

19. The apparatus of claim 15 further comprising instructions to, based on a determination that the instrumentation of the first component provided no additional visibility for performance information of the application, analyze program code of the first component to identify the second component.

20. The apparatus of claim 15 further comprising instructions to determine whether the first component may be instrumented based on at least one of whether the first component belongs to a class which cannot be redefined, whether the first component invokes any other components, and whether the first component has previously been flagged for removal of instrumentation.
